(19) United States
(12) Patent Application Publication
(10) Pub. No.: US 2024/0257423 A1
(43) Pub. Date: Aug. 1, 2024

(54) IMAGE PROCESSING METHOD AND APPARATUS, AND COMPUTER READABLE STORAGE MEDIUM

(71) Applicant: BEIJING WODONG TIANJUN INFORMATION TECHNOLOGY CO., LTD., BEIJING (CN)

(72) Inventors: Dacheng TAO, BEIJING (CN); Wen WANG, BEIJING (CN); Wei ZHAI, BEIJING (CN)

(21) Appl. No.: 18/554,763

(22) PCT Filed: Apr. 15, 2022
(86) PCT No.: PCT/CN2022/086976

§ 371 Date: Apr. 17, 2024

(30) Foreign Application Priority Data
Apr. 16, 2021 (CN) 202110410920.0

(51) Int. Cl. G06T 11/60; G06V 10/774; G06V 10/776

(52) U.S. Cl. CPC G06T 11/60; G06V 10/774; G06V 10/776

(57) ABSTRACT

The present disclosure relates to the technical field of computers, and relates to an image processing method and apparatus, and a computer readable storage medium. The method of the present disclosure comprises: obtaining a source domain content representation of a source domain image, and obtaining a target domain style representation of a target domain image; in order to enable generated new style representations to be different from a source domain style representation of the source domain image and the target domain style representation, enable the new style representations to be different from each other, and enable an image generated by combining the new style representations with the source domain content representation to be semantically consistent with the source domain image, generating multiple new style representations and updating the source domain content representation and the target domain style representation; respectively combining the generated multiple new style representations and the updated target domain style representation with the updated source domain content representation, and respectively generating a first image and a second image; training a target detection model by using the first image, the second image, and the source domain image to obtain a trained target detection model.

### CROSS-REFERENCE TO RELATED APPLICATIONS

The present disclosure is a U.S. National Stage Application under 35 U.S.C. § 371 of International Patent Application No. PCT/CN2022/086976, filed on Apr. 15, 2022, which is based on and claims priority of Chinese application for invention No. 202110410920.0, filed on Apr. 16, 2021, the disclosures of both of which are hereby incorporated into this disclosure by reference in its entirety.

### TECHNICAL FIELD

The present disclosure relates to the field of computer technology, and in particular, to an image processing method and apparatus, and computer readable storage medium.

### BACKGROUND

In practical, an automated and accurate detection of an object of interest to humans in an image has widespread application. For example, through an object detection, an auto drive system can effectively avoid pedestrians and obstacles, a remote sensing system can locate an area of interest, and an industrial production line can screen and locate a defective part.

Existing object detection algorithms usually require be trained based on carefully collected high-quality and unambiguous datasets. In reality, however, due to changes in weather, lighting, object movement, data collection and other reasons, images often suffer from reduced contrast, blur, noise and other quality degradation. Therefore, the actual images configured to object detection are degraded images that have different styles than the training images.

Those domain-adaptation based robust object detection algorithms known to the inventors achieve a representation distribution alignment through an adversarial training and other methods, allowing a model trained on labeled data in a source domain to be generalized to a target domain. This type of methods often assumes that there is only one type of degradation (style) in the target domain.

### SUMMARY

According to some embodiments of the present disclosure, there is provided an image processing method, comprising: obtaining source domain content representations of source domain images and target domain style representations of target domain images; generating multiple new style representations and updating the source domain content representations and the target domain style representations with an objective that the multiple new style representations, which are different from each other, are different from source domain style representations of the source domain images and the target domain style representations, and that images generated by combining the multiple new style representations and the source domain content representations are semantically consistent with the source domain images; generating first images by combining the multiple new style representations with the updated source domain content representations and generating second images by combining the updated target domain style representations with the updated source domain content representations; and training an object detection model using the first images, the second images and the source domain images to obtain the trained object detection model.

In some embodiments, the obtaining source domain content representations of source domain images and target domain style representations of target domain images comprises: extracting the source domain content representations of the source domain images using a content encoder; and extracting the target domain style representations of the target domain images using a style encoder.

In some embodiments, the style encoder comprises a style representation extraction network and a clustering module and the extracting the target domain style representations of the target domain images using a style encoder comprises: inputting the target domain images to the style representation extraction network to obtain basic style representations of the target domain images; and inputting the basic style representations of the target domain images to the clustering module for clustering to obtain representation vectors of clustering centers as the target domain style representations.

In some embodiments, the generating multiple new style representations comprises: randomly generating a preset number of new style representations, and inputting the new style representations and the source domain content representations to a generation network to obtain first transfer images; inputting the target domain style representations and the source domain content representations to the generation network to obtain second transfer images; determining first loss functions according to style differences between the first transfer images and the source domain images, and style differences between the first transfer images and the second transfer images, wherein the first loss f functions are used to represent differences between the new style representations and the source domain style representations, and differences between the new style representations and the target domain style representations; determining second loss functions according to style differences among the first transfer images, wherein the second loss functions are used to represent differences among the new style representations; determining third loss functions according to differences between semantic representations of the first transfer images and semantic representations of the source domain images, wherein the third loss functions are used to represent semantic differences between the source domain images and the images generated by combining the new style representations and the source domain content representations; and adjusting the new style representations according to the first loss functions, the second loss functions, and the third until preset convergence condition loss functions a corresponding to the objective is satisfied, to obtain the multiple new style representations.

In some embodiments, the updating the source domain content representations and the target domain style representations comprises: adjusting parameters of the content encoder, the style encoder, and the generation network according to the first loss functions, the second loss functions, and the third loss functions until the preset convergence condition corresponding to the objective is satisfied; and in a case where the preset convergence condition corresponding to the objective is satisfied, taking source domain content representations output by the content encoder as the updated source domain content representations, and target domain style representations output by the style encoder as the updated target domain style representations.

In some embodiments, taking any of the first transfer images and a source domain image corresponding to the any of the first transfer images as a first reference image and a second reference image respectively, or taking the any of the first transfer images and a second transfer image corresponding to the any of the first transfer images as the first reference image and the second reference image respectively, or taking any two of first transfer images as the first reference image and the second reference image respectively, a style difference between the first reference image and the second reference image is determined in the following method: inputting the first reference image and the second reference image to multiple preset representation layers in a pre-trained representation extraction network; for each of the multiple preset representation layers, determining a mean value and a variance of representations of the first reference image output by the each of the multiple preset representation layers as a first mean value and a first variance, and determining a mean value and a variance of representations of the second reference image output by the each of the multiple preset representation layers as second mean value and a second variance; and determining the style difference between the first reference image and the second reference image according to a difference between the first mean value and the second mean value, as well as a difference between the first variance and the second variance corresponding to the each of the multiple preset representation layers.

In some embodiments, each of the first loss functions is determined using the following formula:

$${ℒ}_{nov}^{i , k} = \frac{{n}_{s}}{n} max \{ 0 , {T}_{nov} - d ( {x}_{k}^{s} , {x}_{k}^{s \to {n}_{i}} ) \} + {\sum }_{j = 1}^{{K}_{t}} \frac{{n}_{j}}{n} max \{ 0 , {T}_{nov} - d ( {x}_{k}^{s \to {t}_{j}} , {x}_{k}^{s \to {n}_{i}} ) \}$$

wherein [symbol] ₙₒᵥ^{i,k} represents a first loss function corresponding to an i^{th} new style representation and a k^{th} source domain image; k is a positive integer, 1≤k≤nₛ; i is a positive integer; n=nₛ+nₜ represents a total number of the source domain images and the target domain images, nₛ and nₜ represent a number of the source domain images and a number of the target domain images respectively; nⱼ represents a number of the target images corresponding to a j^{th} target domain style representation; Kₜ represents a number of the target domain style representations; Tₙₒᵥ is a hyperparameter representing a maximized distance threshold; j is a positive integer, 1≤j≤Kₜ; xₖ^{s} represents the k^{th} source domain image; xₖ^{s→n}^{ᵢ} represents a first transfer image generated by inputting the i^{th} new style representation and a source domain content representation of the k^{th} source domain image to the generation network; xₖ^{s→t}^{ⱼ} represents a second transfer image generated by inputting the j^{th} target domain style representation and the source domain content representation of the k^{th} source domain image to the generation network; and d(⋅) represents a determination function of a style difference between two images.

In some embodiments, each of the second loss functions is determined using the following formula:

$${ℒ}_{div}^{i , k} = \frac{1}{{K}_{n} - 1} {\sum }_{j = 1 , j \neq i}^{{K}_{n}} max \{ 0 , {T}_{div} - {d}_{s} ( {x}_{k}^{s \to {n}_{j}} , {x}_{k}^{s \to {n}_{i}} ) \}$$

wherein [symbol] _{div}^{i,k} represents a second loss function corresponding to an i^{th} new style representation and a k^{th} source domain image, 1≤i≤Kₙ; i is a positive integer; Kₙ represents the preset number; T_{div} is a hyperparameter representing a maximized distance threshold; xₖ^{s→n}^{ⱼ} represents a first transfer image generated by inputting a j^{th} new style representation and a source domain content representation of the k^{th} source domain image to the generation network, wherein j is a positive integer, 1≤Kₙ; x^{s→n}^{ᵢ} represents a first transfer image generated by inputting the i^{th} new style representation and the source domain content representation of the k^{th} source domain image to the generation network; and d(⋅) represents a determination function of a style difference between two images.

In some embodiments, each of the third loss functions is determined according to the following formula:

$${ℒ}_{s m}^{i , k} = {‖ {ϕ}_{s m} ( {x}_{k}^{s} ) - {ϕ}_{s m} ( {x}_{k}^{s \to {n}_{i}} ) ‖}_{2}$$

wherein [symbol] ₛₘ^{i,k} represents a third loss function corresponding to an i^{th} new style representation and a k^{th} source domain image; ϕₛₘ(⋅) represents a function of a semantic representation extractor; xₖ^{s} represents the k^{th} source domain image; and xₖ^{s→n}^{ᵢ} represents a first transfer image obtained by inputting the i^{th} new style representation and a source domain content representation of the k^{th} source domain image to the generation network.

In some embodiments, the adjusting the new style representations according to the first loss functions, the second loss functions, and the third loss functions comprises: obtaining a target loss function by weighting and summing the first loss functions, the second loss functions and the third loss functions; determining a gradient according to the target loss function; and adjusting the new style representations according to the gradient and a preset learning rate, wherein a value of each dimension in the randomly generated preset number of the new style representations is randomly sampled from a standard normal distribution.

In some embodiments, the generating first images by combining the multiple new style representations with the updated source domain content representations and generating second images by combining the updated target domain style representations with the updated source domain content representations comprises: in a case where the preset convergence condition corresponding to the objective is satisfied, inputting the multiple new style representations and the updated source domain content representations to the generation network to obtain the first images, and inputting the updated target domain style representations and the updated source domain content representations to the generation network to obtain the second images.

In some embodiments, the training an object detection model using the first images, the second images and the source domain images comprises: inputting the first images to the object detection model to obtain object detection results of the first images, inputting the second images to the object detection model to obtain object detection results of the second images, and inputting the source domain images to the object detection model to obtain object detection results of the source domain images; determining an object detection loss function according to differences of labeling information of the source domain images with the object detection results of the first images, with the object detection results of the second images, and with the object detection results of the source domain images; and adjusting parameters of the object detection model according to the object detection loss function.

In some embodiments, the training an object detection model using the first images, the second images and the source domain images further comprises: inputting the first images to a basic representation extraction network of the object detection model to obtain basic representations of the first images, inputting the second images to the basic representation extraction network of the object detection model to obtain basic representations of the second images, inputting the source domain images to the basic representation extraction network of the object detection model to obtain basic representations of the source domain images, and inputting the target domain images to the basic representation extraction network of the object detection model to obtain basic representations of the target domain images; and inputting the basic representations of the first images to a gradient inversion layer and then to a discrimination network to obtain discrimination results of the first images, inputting the basic representations of the second images to the gradient inversion layer and then to the discrimination network to obtain discrimination results of the second images, inputting the basic representations of the source domain images to the gradient inversion layer and then to the discrimination network to obtain discrimination results of the source domain images, and inputting the basic representations of the target domain images to the gradient inversion layer and then to the discrimination network to obtain discrimination results of the target domain images; and determining a discrimination loss function according to the discrimination results of the first images, the discrimination results of the second images, the discrimination results of the source domain images, and the discrimination results of the target domain images, wherein the adjusting parameters of the object detection model according to the object detection loss function comprises: adjusting the parameters of the object detection model according to the object detection loss function and the discrimination loss function.

In some embodiments, the object detection results comprise positioning results and classification results, wherein the positioning results are positions of detected objects, the classification results are categories of the detected objects, and the labeling information of the source domain images comprise positions of objects in the source domain images and categories of the objects in the source domain images; and the determining an object detection loss function according to the differences of labeling information of the source domain images with the object detection results of the first images, with the object detection results of the second images, and with the object detection results of the source domain images comprises: determining positioning loss functions according to differences of the positions of the objects in the source domain images with the positioning results of the first images, with the positioning results of the second images, and with the positioning results of the source domain images; determining classification loss functions according to differences of the categories of the objects in the source domain images with the classification results of the first images, with the classification results of the second images, and with the classification results of the source domain images; and weighting and summing the positioning loss functions and the classification loss functions to obtain the object detection loss function.

In some embodiments, each of the positioning loss functions is determined using the following formula:

$${ℒ}_{L O C}^{k} = {ℒ}_{loc} ( {x}_{k}^{s} , {y}_{k , l}^{s} ) + {\sum }_{i = 1}^{{N}_{d}} {ℒ}_{loc} ( {x}_{k}^{s \to {d}_{i}} , {y}_{k , l}^{s} )$$

wherein [symbol] _{LOC}^{k} represents a positioning loss corresponding to a k^{th} source domain image; xₖ^{s} represents the k^{th} source domain image; y_{k,l}^{s} represents a position of an object in the k^{th} source domain image, [symbol] _{loc}(xₖ^{s}, y_{k,l}^{s}) represents a positioning loss determined by a positioning result of the k^{th} source domain image and the position of the object in the k^{th} source domain image; dᵢ represents an i^{th} style representation in a set of the multiple new style representations and the updated target domain style representations; xₖ^{s→d}^{ᵢ} represents an image generated by combining the i^{th} style representation with a source domain content representation updated of the k^{th} source domain image, which is one of the first images or one of the second images; [symbol] _{loc}(xₖ^{s→d}^{ᵢ}, y_{k,l}^{s}) represents a positioning loss corresponding a the positioning result of the image xₖ^{s→d}^{ᵢ} and the position of the object in the k^{th} source domain image, 1≤i≤N_{d} and i is a positive integer; and N_{d} represents a total number of style representations in the set of the multiple new style representations and the updated target domain style representations.

In some embodiments, each of the classification loss functions is determined using the following formula:

$${ℒ}_{CLS}^{k} = {L}_{c l s} ( {x}_{k}^{s} , {y}_{k , c}^{s} ) + {\sum }_{i = 1}^{{N}_{d}} {ℒ}_{cls} ( {x}_{k}^{s \to {d}_{i}} , {y}_{k , c}^{s} )$$

wherein [symbol] _{CLS}^{k} represents a classification loss corresponding to a k^{th} source domain image; xₖ^{s} represents the k^{th} source domain image; y_{k,c}^{s} represents a category of an object in the k^{th} source domain image; [symbol] _{cls}(xₖ^{s}, y_{k,c}^{s}) is the classification loss corresponding to a classification result of the k^{th} source domain image and the category of the object in the k^{th} source domain image; dᵢ represents an i^{th} style representation in a set of the multiple new style representations and the updated target domain style representations; xₖ^{s→d}^{ᵢ} represents an image generated by combining the i^{th} style representation with a source domain content representation updated of the k^{th} source domain image, which is one of the first images or one of the second images; [symbol] _{cls}(xₖ^{s→d}^{ᵢ}, y_{k,c}^{s}) represents a classification loss corresponding to a classification result of the image xₖ^{s→d}^{ᵢ} and the category of the object in the k^{th} source domain image, 1≤i≤N_{d} and i is a positive integer; and N_{d} represents a total number of style representations in the set of the multiple new style representations and the updated target domain style representations.

In some embodiments, the discrimination loss function is determined using the following formulas:

$${ℒ}_{MDA}^{s} = {\sum }_{i = 1}^{{n}_{s}} {ℒ}_{mda} ( {x}_{i}^{s} , 0 )$$

$${ℒ}_{MDA}^{t} = {\sum }_{j = 1}^{{n}_{t}} {ℒ}_{mda} ( {x}_{j}^{t} , {c}_{j}^{t} )$$

$${ℒ}_{MDA}^{ST} = {\sum }_{i = 1}^{{n}_{s}} {\sum }_{k = 1}^{{N}_{d}} {ℒ}_{mda} ( {x}_{i}^{s \to {d}_{k}} , k )$$

$${ℒ}_{MDA} = {ℒ}_{MDA}^{s} + {ℒ}_{MDA}^{t} + {ℒ}_{MDA}^{S T}$$

wherein xᵢ^{s} represents an i^{th} source domain image; nₛ represents a number of the source domain images; Σᵢ₌₁ⁿ^{ₛ} [symbol] _{mda}(xᵢ^{s}, 0) represents a source domain discrimination loss function determined according o the discrimination results of the source domain images; xⱼ^{t} represents a j^{th} target domain image; cⱼ^{t} represents a style to which the j^{th} target domain image belongs; nₜ represents a number of the target domain images, 1≤j≤nₜ and j is a positive integer; Σⱼ₌₁ⁿ^{ₜ} [symbol] _{mda}(xⱼ^{t}, cⱼ^{t}) represents a target domain discrimination loss function determined according to the discrimination results of the target domain images; dₖ represents a k^{th} style representation in a set of the multiple new style representations and the updated target domain style representations; xₖ^{s→d}^{ᵢ} represents an image generated by combining the k^{th} style representation with a source domain content representation updated of the i^{th} source domain image, 1≤k≤N_{d} and k is a positive integer; N_{d} represents a total number of style representations in the set of the multiple new style representations and the updated target domain style representations; and Σᵢ₌₁ⁿ^{ₛ}Σₖ₌₁^{N}^{_{d}} [symbol] _{mda}(xᵢ^{s→d}^{ₖ}, k) represents the discrimination loss function determined according to the discrimination results of the first images and the discrimination results of the second images.

In some embodiments,

$${ℒ}_{mda} ( {x}_{i}^{s} , 0 ) = - {\sum }_{h = 1}^{H} {\sum }_{w = 1}^{W} log ( D ( F ( {x}_{i}^{s} ) ) ( h , w ) )$$

$${ℒ}_{mda} ( {x}_{j}^{t} , {c}_{j}^{t} ) = - {\sum }_{h = 1}^{H} {\sum }_{w = 1}^{W} log ( D ( F ( {x}_{j}^{t} ) ) ( {c}_{j}^{t} , h , w ) )$$

$${ℒ}_{mda} ( {x}_{i}^{s \to {d}_{k}} , k ) = - {\sum }_{h = 1}^{H} {\sum }_{w = 1}^{W} log ( D ( F ( {x}_{i}^{s \to {d}_{k}} ) ) ( k , h , w ) )$$

wherein 1≤h≤H, h is a positive integer representing a height of pixels in the image; 1≤w≤W, w is a positive integer representing the width of pixels in the image; H and W represent a maximum height and a maximum width of pixels in the image, respectively; and F(⋅) represents a function of the basic representation extraction network and the gradient inversion layer.

In some embodiments, the method further comprises inputting an image to be detected to the trained object detection model to obtain an object detection result of the image to be detected.

According to other embodiments of the present disclosure, there is provided an image processing apparatus, comprising: a processor; a memory coupled to the processor for storing instructions that, when executed by the processor, cause the processor to execute the image processing method of any one of the foregoing embodiments.

According to still other embodiments of the present disclosure, there is provided a non-transitory computer-readable storage medium on which a computer program is stored, wherein the program, when executed by a processor, cause the processor to implement the image processing method of any one of the foregoing embodiments.

Other representations and advantages of the present invention will become apparent from the following detailed description of exemplary embodiments of the present disclosure with reference to the accompanying drawings.

### BRIEF DESCRIPTION OF THE DRAWINGS

The accompanying drawings, which comprised to provide a further understanding of the present disclosure and are incorporated in and constitute a part of this specification, illustrate embodiments of the invention, and together with the illustrative embodiments of the present application serve to explain the present disclosure, but are not limitation thereof.

FIG. 1 shows a flowchart of an image processing method according to some embodiments of the present disclosure;

FIG. 2 shows a schematic diagram of the network architecture according to some embodiments of the present disclosure;

FIG. 3 shows a schematic diagram of the structure of an image processing device according to some embodiments of the present disclosure;

FIG. 4 shows a schematic diagram of the structure of an image processing device according to other embodiments of the present disclosure;

FIG. 5 shows a schematic diagram of the structure of an image processing device according to still other embodiments of the present disclosure.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The following description of at least one exemplary embodiment is in fact merely illustrative and is in no way intended as a limitation to the invention, its application or use. All other embodiments obtained by those of ordinary skill in the art based on the embodiments of the present disclosure without creative efforts shall fall within the protection scope of the present disclosure.

The inventors have found that, in reality, a trained object detection model needs to accurately detect objects in images of different types of degradation (styles). However, object detection models trained by existing methods cannot recognize images of different styles. In addition, an acquisition and a labeling of images of different styles for training in real-world scenarios requires a significant amount of manpower and resources.

A technical problem to be solved by the present disclosure is how to improve the efficiency and effectiveness of training an object detection model.

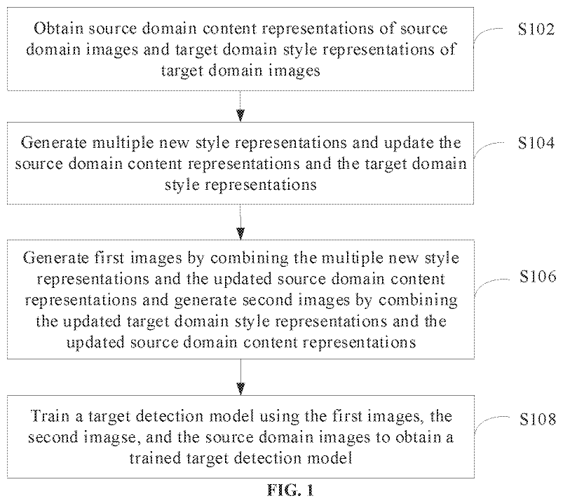

The present disclosure provides an image processing method, which will be described below with reference to FIGS. 1 to 3.

FIG. 1 is a schematic diagram of an image processing method according to some embodiments of the present disclosure. As shown in FIG. 1, the method of these embodiments comprises: steps S102 to S108.

In step S102, source domain content representations of source domain images and target domain style representations of target domain images are obtained.

For example, [symbol] ₛ={(xᵢ^{s}, yᵢ^{s})}ᵢ₌₁ⁿ^{ₛ} represents a set of source domain images with labels, wherein xᵢ^{s} represents an i^{th} source domain image; yᵢ^{s} represents labeling information (label) corresponding to the i^{th} source domain image. The labeling information comprises a semantic label, such as a position of an object in the source domain image and/or a category of the object in the source domain image. The labeling information may also comprise a domain label, which represents a style of the source domain image. nₛ is the number of the source domain images. A set of target domain images without labels can be represented as [symbol] ₜ={(xᵢ^{t})}ᵢ₌₁ⁿ^{ₜ}, wherein xᵢ represents an i^{th} target domain image, and nₜ is the number of the target domain images.

Content representations are used to reflect semantic information of an image, for example, semantic categories (vehicle, person, background, etc.) to which different pixels belong. Style representations are used to reflect a type of degradation of an image. For example, due to weather changes, collected images may become unclear under the influence of rain, snow, or fog; due to changes in lighting, the collected images may have issues such as overexposure and low lighting; due to an influence of a collection equipment and process, the images may have issues such as blurring and noise. The source domain images and the target domain images have the same or similar semantic information, but different types of degradation, that is, style representations.

In some embodiments, source domain content representations of the source domain images are extracted using a content encoder; target domain style representations of the target domain images are extracted using a style encoder. Different encoders can be used to encode style representations and content representations, which then can be decoupled for images. The content encoder and style encoder may be convolutional neural networks (CNN), such as VGGNet or ResNet.

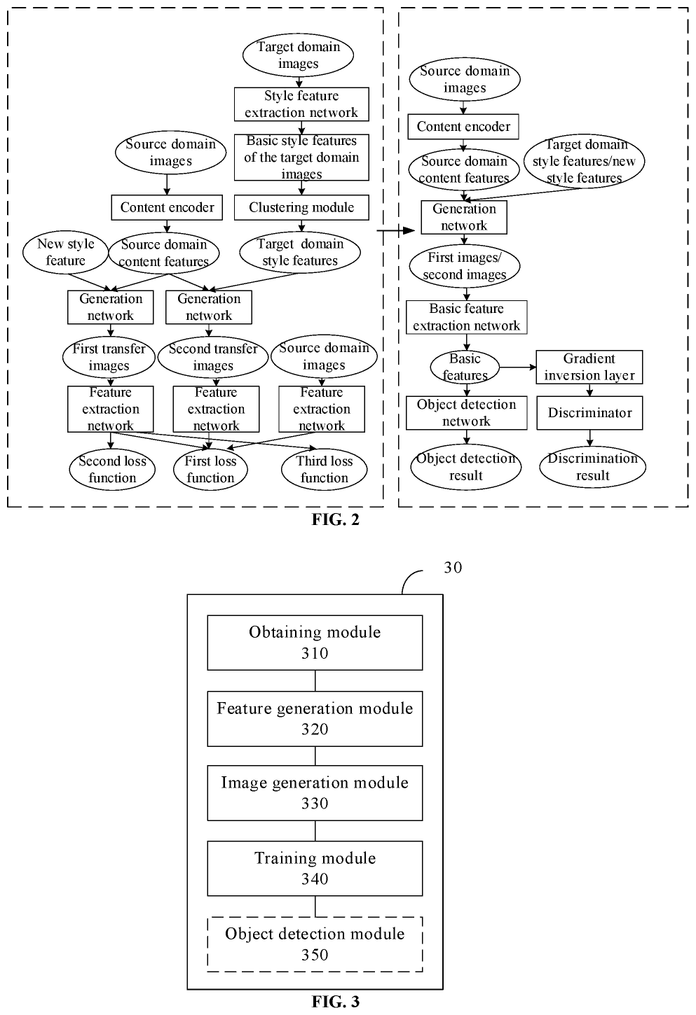

In some embodiments, as shown in FIG. 2, the style encoder comprises a style representation extraction network and a clustering module. The target domain images can be input to the style representation extraction network to obtain basic style representations of the target domain images; the basic style representations of the target domain images can be input to the clustering module for clustering to obtain representation vectors of clustering centers as the target domain style representations.

The source domain images can all belong to one style, and the target domain images can belong to one or more styles. Due to a lack of the labeling information in the target domain images, a clustering algorithm can be used to obtain one or more representations of one or more clustering centers of the target domain images, which can be used as one or more target domain style representations to represent different styles. Any existing algorithm can be adopted as the clustering algorithm, such as K-means, mean shift clustering, or density based clustering algorithm, etc. By clustering, each of the target domain images can be labeled with a pseudo domain label, that is, each of the target domain images may be labeled with a style.

In step S104, multiple new style representations are generated and the source domain content representations and the target domain style representations are updated with an objective that the multiple new style representations, which are different from each other, are different from source domain style representations of the source domain images and the target domain style representations, and that images generated by combining the multiple new style representations and the source domain content representations are semantically consistent with the source domain images.

To achieve the above objective, different loss functions can be established for training. In some embodiments, as shown in FIG. 2, the generating multiple new style representations comprises: randomly generating a preset number of new style representations, and inputting the new style representations and the source domain content representations to a generation network to obtain first transfer images; inputting the target domain style representations and the source domain content representations to the generation network to obtain second transfer images; determining first loss functions according to style differences between the first transfer images and the source domain images, and style differences between the first transfer images and the second transfer images, wherein the first loss functions are used to represent differences between the new style representations and the source domain style representations, and differences between the new style representations and the target domain style representations; determining second loss functions according to style differences among the first transfer images, wherein the second loss functions are used to represent differences among the new style representations; determining third loss functions according to differences between semantic representations of the first transfer images and semantic representations of the source domain images, wherein the third loss functions are used to represent semantic differences between the source domain images and the images generated by combining the new style representations and the source domain content representations; and adjusting the new style representations according to the first loss functions, the second loss functions, and the third loss functions until a preset convergence condition corresponding to the objective is satisfied, to obtain the multiple new style representations.

The preset number can be the same as a number of target domain style representations (i.e. the number of styles to which the target domain images belong). For example, a value of each dimension in the randomly generated preset number of the new style representations is randomly sampled from a standard normal distribution.

The generation network is used to fuse style representations and content representations, which can comprise, but is not limited to, an existing model, such as a CNN. The new style representations and source domain content representations can be inputted to the generation network to obtain images transferred from the source domain to new domains, that is, the first transfer images. The target domain style representations and source domain content representations can be inputted to the generation network to obtain images transferred from the source domain to the target domain, that is, the second transfer images.

The first loss functions and the second loss functions are both determined based on style differences between two images. In some embodiments, taking any of the first transfer images and a source domain image of the source domain images corresponding to the any of the first transfer images as a first reference image and a second reference image respectively, or taking the any of the first transfer images and a second transfer image of the second transfer images corresponding to the any of the first transfer images as the first reference image and the second reference image respectively, or taking any two of first transfer images as the first reference image and the second reference image respectively, a style difference between the first reference image and the second reference image is determined in the following method. The source domain image corresponding to the first transfer image is the source domain image to which the source domain content representation used to generate the first transfer image belongs. Similarly, the second transfer image corresponding to the first transfer image is the second transfer image generated using the same source domain content representations as the first transfer image.

The first reference image and the second reference image are input to multiple preset representation layers of a pre-trained representation extraction network (as shown in FIG. 2); for each of the multiple preset representation layers, a mean value and a variance of representations of the first reference image output by the each of the multiple preset representation layers are determined as a first mean value and a first variance, and a mean value and a variance of representations of the second reference image output by the each of the multiple preset representation layers are determined as second mean value and a second variance; and the style difference between the first reference image and the second reference image is determined according to a difference between the first mean value and the second mean value, as well as a difference between the first variance and the second variance corresponding to the each of the multiple preset representation layers. The greater the difference between the first mean and the second mean and the greater the difference between the first variance and the second variance corresponding to each of the representation layers, the greater the style difference between the first reference image and the second reference image.

The pre-trained representation extraction network may be, but is not limited to, a pre-trained VGG19. For example, the style difference between the first reference image and the second reference image is determined using the following formula:

$$d ( {x}_{1} , {x}_{2} ) = {\sum }_{i = 1}^{L} {‖ μ ( {ϕ}_{i} ( {x}_{1} ) ) - μ ( {ϕ}_{i} ( {x}_{2} ) ) ‖}_{2} + {\sum }_{i = 1}^{L} {‖ σ ( {ϕ}_{i} ( {x}_{1} ) ) - σ ( {ϕ}_{i} ( {x}_{2} ) ) ‖}_{2} \qquad ( 1 )$$

In formula (1), x₁, x₂ represent the first reference image and the second reference image, 1≤i≤ [symbol] , wherein i is a positive integer, and [symbol] represents a number of the representation layers in the pre-trained representation extraction network; ϕᵢ(⋅) represents a function of an i^{th} layer in the pre-trained representation extraction network, μ(⋅) represents a function of finding a mean value, and σ(⋅) represents a function of finding a variance.

In some embodiments, the first loss functions are used to represent differences between the new style representations and the source domain style representations, and difference between the new style representations and the target domain style representations. Training with the first loss functions can make the new style representations different from existing style representations in the source domain and the target domain, so as to complement existing styles. For example, the first loss function is determined according to the following formula:

$${ℒ}_{nov}^{i , k} = \frac{{n}_{s}}{n} max \{ 0 , {T}_{nov} - d ( {x}_{k}^{s} , {x}_{k}^{s \to {n}_{i}} ) \} + {\sum }_{j = 1}^{{K}_{t}} \frac{{n}_{j}}{n} max \{ 0 , {T}_{nov} - d ( {x}_{k}^{s \to {t}_{j}} , {x}_{k}^{s \to {n}_{i}} ) \} \qquad ( 2 )$$

In formula (2), [symbol] ₙₒᵥ^{i,k} represents a first loss function corresponding to an i^{th} new style representation and a k^{th} source domain image; k is a positive integer, 1≤k≤nₛ; i is a positive integer; n=nₛ+nₜ represents a total number of the source domain images and the target domain images, nₛ and nₜ represent a number of the source domain images and a number of the target domain images respectively; nⱼ represents a number of the target images corresponding to a j^{th} target domain style representation; Kₜ represents a number of the target domain style representations; Tₙₒᵥ is a hyperparameter representing a maximized distance threshold; j is a positive integer, 1≤j≤ Kₜ; xₖ^{s} represents the k^{th} source domain image; xₖ^{s→n}^{ᵢ} represents a first transfer image generated by inputting the i^{th} new style representation and a source domain content representation of the k^{th} source domain image to the generation network; xₖ^{s→t}^{ⱼ} represents a second transfer image generated by inputting the j^{th} target domain style representation and the source domain content representation of the k^{th} source domain image to the generation network; d(⋅) represents a determination function of a style difference between two images.

In some embodiments, the second loss functions are used

to represent differences between among the new style representations. Training with the second loss function can make the generated new style representations different from each other to ensure the diversity of the generated new domains. For example, the second loss function is determined according to the following formula:

$${ℒ}_{div}^{i , k} = \frac{1}{{K}_{n} - 1} {\sum }_{j = 1 , j \neq i}^{{K}_{n}} max \{ 0 , {T}_{div} - {d}_{s} ( {x}_{k}^{s \to {n}_{j}} , {x}_{k}^{s \to {n}_{i}} ) \} \qquad ( 3 )$$

In formula (3), [symbol] _{div}^{i,k} represents a second loss function corresponding to an i^{th} new style representation and a k^{th} source domain image, 1≤i≤Kₙ; i is a positive integer; Kₙ represents the preset number; T_{div} is a hyperparameter representing a maximized distance threshold; xₖ^{s→n}^{ⱼ} represents a first transfer image generated by inputting a j^{th} new style representation and a source domain content representation of the k^{th} source domain image to the generation network, wherein j is a positive integer, 1≤j≤Kₙ; x^{s→n}^{ᵢ} represents a first transfer image generated by inputting the i^{th} new style representation and the source domain content representation of the k^{th} source domain image to the generation network; d(⋅) represents a determination function of a style difference between two images.

In some embodiments, the semantic representations of the first transfer images and the semantic representations of the source domain images are obtained using a semantic representation extractor. The third loss functions are used to represent semantic differences between the source domain images and the images (first transfer images) generated by combining the new style representations and the source domain content representations. Training with the third loss functions can make the first transfer images semantically consistent with their corresponding source domain images, so that the semantic labels in the source domain can be applied to the images generated. For example, the third loss function is determined according to the following formula:

$${ℒ}_{sm}^{i , k} = {‖ {ϕ}_{sm} ( {x}_{k}^{s} ) - {ϕ}_{sm} ( {x}_{k}^{s \to {n}_{i}} ) ‖}_{2} \qquad ( 4 )$$

In formula (4), [symbol] ₛₘ^{i,k} represents a third loss function corresponding to an i^{th} new style representation and a k^{th} source domain image; ϕₛₘ(⋅) represents a function of a semantic representation extractor; xₖ^{s} represents the k^{th} source domain image; xₖ^{s→n}^{ᵢ} represents a first transfer image obtained by inputting the i^{th} new style representation and a source domain content representation of the k^{th} source domain image to the generation network.

In some embodiments, the first loss function, the second loss function, and the third loss function are weighted and summed to obtain a target loss function. For example, the target loss function is determined according to the following formula:

$${ℒ}_{total} = {\sum }_{k = 1}^{{n}_{s}} {\sum }_{i = 1}^{{K}_{n}} ( {ℒ}_{nov}^{i , k} + {λ}_{1} {ℒ}_{div}^{i , k} + {λ}_{2} {ℒ}_{sm}^{i , k} ) \qquad ( 5 )$$

In formula (5), 1≤k≤nₛ, λ₁ and λ₂ are the weights of [symbol] _{div}^{i,k} and [symbol] ₛₘ^{i,k} respectively.

In some embodiments, in each training iteration (epoch) a gradient is determined according to the target loss function; the new style representations are adjusted according to the gradient and a preset learning rate. For example, adjusted new style representations can be obtained by subtracting the product of the gradient and the preset learning rate from vectors corresponding to the new style representations.

In some embodiments, in addition to adjusting the new style representations, parameters of the content encoder, the style encoder, and the generator are adjusted according to the first loss functions, the second loss functions, and the third loss functions until the preset convergence condition corresponding to the objective is satisfied; in a case where the preset convergence condition corresponding to the objective is satisfied, the source domain content representations output by the content encoder are used as the updated source domain content representations, and the target domain style representations output by the style encoder are used as the updated target domain style representations.

For example, in each epoch, a gradient is determined according to the target loss function; and parameters of the content encoder, the style encoder, and the generator are adjusted according to the gradient and the preset learning rate. Moreover, the parameters of the semantic representation extractor can also be adjusted.

In each epoch, the new style representations are adjusted according to the target loss function, and the parameters of the content encoder, the style encoder, the generator and the semantic representation extractor are adjusted. The new style representations adjusted and the updated source domain content representations are input to the generation network to obtain the first transfer images; The updated target domain style representations and the updated source domain content representations are input to the generation network to obtain the second transfer images; the first loss functions are determined according to the style differences between the first transfer images and the source domain images, and the style differences between the first transfer images and the second transfer images; the second loss functions are determined according to the style differences among the first transfer images; the third loss functions are determined according to differences between the semantic representations of the first transfer images and the semantic representations of the source domain images; a target loss function is determined according to the first loss functions, the second loss functions, and the third loss functions. The above process is repeated until the preset convergence condition corresponding to the objective is reached. For example, the preset convergence condition is a minimum value of the target loss function, which is not limited in this disclosure.

In step S106, first images are generated by combining the multiple new style representations and the updated source domain content representations and second images are generated by combining the updated target domain style representations and the updated source domain content representations.

In some embodiments, in a case where the preset convergence condition corresponding to the objective is satisfied, the multiple new style representations and the updated source domain content representations are input to the generation network to obtain the first images, and the updated target domain style representations and the updated source domain content representations are input to the generation network to obtain the second images. By utilizing the training process of the aforementioned embodiment, the generation network trained can be obtained. The first images and the second images are generated using the generation network trained, as shown in FIG. 2.

In step S108, an object detection model is trained using the first images, the second images, and the source domain images to obtain the trained object detection model.

Steps S102 to S104 are a first stage of a training process, which involves an adversarial exploration of novel styles to obtain the updated source domain content representations, the updated target domain style representations, and the new style representations adversarially generated. Then, step S106 is used to generate the first and second images used in a second stage of the training process (step S108), i.e., to train an object detection model in an invariant training domain.

Because both the first images and the second images are generated based on the same source domain content representations, the first images and the second images have the same content representation representations as the source domain images which corresponds to the first images and the second images, and their semantic labels are consistent, so that the source domain semantic labels can be used as the semantic labels of the first images and the second images.

In some embodiments, the first images are input to the object detection model to obtain object detection results of the first images, the second images are input to the object detection model to obtain object detection results of the second images, and the source domain images are input to the object detection model to obtain object detection results of the source domain images; an object detection loss function is determined according to differences of labeling information of the source domain images with the object detection results of the first images, with the object detection results of the second images, and with the object detection results of the source domain images; parameters of the object detection model are adjusted according to the object detection loss function. The source domain images corresponding to the first images or the second images refer to the source domain images to which the source domain content representations used to generate the first images or the second images belong.

In some embodiments, as shown in FIG. 2, the object detection model comprises a basic representation extraction network and an object detection network. The first images, the second images, and the source domain images are respectively input to the basic representation extraction network to obtain basic representations of the first images, basic representations of the second images, and basic representations of the source domain images. Then, the basic representations of the first images, the basic representations of the second images, and the basic representations of the source domain images are input to the object detection network to obtain the object detection results of the first images, the object detection results of the second images, and the object detection results of the source domain images.

In some embodiments, the object detection result comprises positioning results and/or classification results. The positioning results are positions of detected objects (for example, coordinates of rectangular boxes of the detected objects), the classification results are categories of the detected objects (for example, the categories comprise vehicle, person, background, etc.); the labeling information of the source domain images comprise positions of objects in the source domain images and/or categories of the objects in the source domain images.

In a case where the object detection results comprises the positioning results and the classification results, positioning loss functions are determined according to differences of the positions of the objects in the source domain images with the positioning results of the first images, with the positioning results of the second images, and with the positioning results of the source domain images; classification loss functions are determined according to differences of the categories of the objects in the source domain images with the classification results of the first images, with the classification results of the second images, and with the classification results of the source domain images; the positioning loss functions and the classification loss functions are weighted and summed to obtain the object detection loss function. If the object detection results only comprise the positioning results or the classification results, only the positioning loss functions or the classification loss functions are determined, which will not be repeated.

In some embodiments, each of the positioning loss functions is determined according to the following formula:

$${ℒ}_{LOC}^{k} = {ℒ}_{loc} ( {x}_{k}^{s} , {y}_{k , l}^{s} ) + {\sum }_{i = 1}^{{N}_{d}} {ℒ}_{loc} ( {x}_{k}^{s \to {d}_{i}} , {y}_{k , l}^{s} ) \qquad ( 6 )$$

In formula (6), wherein [symbol] _{LOC}^{k} represents a positioning loss corresponding to a k^{th} source domain image; xₖ^{s} represents the k^{th} source domain image; y_{k,i}^{s} represents a position of an object in the k^{th} source domain image, [symbol] _{loc}(xₖ^{s}, y_{k,l}^{s}) represents a positioning loss determined by a positioning result of the k^{th} source domain image and the position of the object in the k^{th} source domain image; dᵢ represents an i^{th} style representation in a set of the multiple new style representations and the updated target domain style representations; xₖ^{s→d}^{ᵢ} represents an image generated by combining the i^{th} style representation with a source domain content representation updated of the k^{th} source domain image, which is one of the first images or one of the second images; [symbol] _{loc}(xₖ^{s→d}^{ᵢ}, y_{k,l}^{s}) represents a positioning loss corresponding a the positioning result of the image xₖ^{s→d}^{ᵢ} and the position of the object in the k^{th} source domain image, 1≤i≤N_{d} and i is a positive integer; N_{d} represents a total number of style representations in the set of the multiple new style representations and the updated target domain style representations.

In some embodiments, each of the classification loss functions is determined according to the following formula:

$${ℒ}_{CLS}^{k} = {ℒ}_{cls} ( {x}_{k}^{s} , {y}_{k , c}^{s} ) + {\sum }_{i = 1}^{{N}_{d}} {ℒ}_{cls} ( {x}_{k}^{s \to {d}_{i}} , {y}_{k , c}^{s} ) \qquad ( 7 )$$

In formula (7), [symbol] _{CLS}^{k} represents a classification loss corresponding to a k^{th} source domain image; xₖ^{s} represents the k^{th} source domain image; y_{k,c}^{s} represents a category of an object in the k^{th} source domain image; [symbol] _{cls}(xₖ^{s}, y_{k,c}^{s}) is the classification loss corresponding to a classification result of the k^{th} source domain image and the category of the object in the k^{th} source domain image; dᵢ represents an i^{th} style representation in a set of the multiple new style representations and the updated target domain style representations; xₖ^{s→d}^{ᵢ} represents an image generated by combining the i^{th} style representation with a source domain content representation updated of the k^{th} source domain image, which is one of the first images or one of the second images; [symbol] _{cls}(xₖ^{s→d}^{ᵢ}, y_{k,c}^{s}) represents a classification loss corresponding to a classification result of the image xₖ^{s→d}^{ᵢ} and the category of the object in the k^{th} source domain image, 1≤i≤N_{d} and i is a positive integer; N_{d} represents a total number of style representations in the set of the multiple new style representations and the updated target domain style representations.

In order to further improve the accuracy of the object detection model, a discriminator can be added to train the object detection model through domain discrimination results. In some embodiments, as shown in FIG. 2, the basic representations of the first images, the basic representations of the second images, the basic representations of the source domain images, and the basic representations of the target domain images are input to a gradient inversion layer and then to a discrimination network to obtain discrimination results of the first images, discrimination results of the second images, discrimination results of the source domain images, and discrimination results of the target domain images; a discrimination loss function is determined according to the discrimination results of the first images, the discrimination results of the second images, the discrimination results of the source domain images, and the discrimination results of the target domain images; the parameters of the object detection model are adjusted according to the object detection loss function and the discrimination loss function.

Before the various basic representations are input to the discriminator, they are input to the gradient inversion layer to invert the gradients of the representations, allowing the discriminator and the basic representation extraction network to optimize in opposite directions, forcing the basic representation extraction network to learn domain-invariant representations.

In some embodiments, the discrimination loss function is determined according to the following formulas:

$${ℒ}_{MDA}^{s} = {\sum }_{i = 1}^{{n}_{s}} {ℒ}_{mda} ( {x}_{i}^{s} , 0 ) \qquad ( 8 )$$

$${ℒ}_{MDA}^{t} = {\sum }_{j = 1}^{{n}_{t}} {ℒ}_{mda} ( {x}_{j}^{t} , {c}_{j}^{t} ) \qquad ( 9 )$$

$${ℒ}_{MDA}^{ST} = {\sum }_{i = 1}^{{n}_{s}} {\sum }_{k = 1}^{{N}_{d}} {ℒ}_{mda} ( {x}_{i}^{s \to {d}_{k}} , k ) \qquad ( 10 )$$

$${ℒ}_{MDA} = {ℒ}_{MDA}^{s} + {ℒ}_{MDA}^{t} + {ℒ}_{MDA}^{ST} \qquad ( 11 )$$

In formulas (8) to (10), xᵢ^{s} represents an i^{th} source domain image; nₛ represents a number of the source domain images; Σᵢ₌₁ⁿ^{ₛ} [symbol] _{mda}(xᵢ^{s}, 0) represents a source domain discrimination loss function determined according to the discrimination results of the source domain images; xⱼ^{t} represents a j^{th} target domain image; cⱼ^{t} represents a style to which the j^{th} target domain image belongs; nₜ represents a number of the target domain images, 1≤j≤nₜ and j is a positive integer; Σⱼ₌₁ⁿ^{ₜ} [symbol] _{mda}(xⱼ^{t}, cⱼ^{t}) represents a target domain discrimination loss function determined according to the discrimination results of the target domain images; dₖ represents a k^{th} style representation in a set of the multiple new style representations and the updated target domain style representations; xₖ^{s→d}^{ᵢ} represents an image generated by combining the k^{th} style representation with a source domain content representation updated of the i^{th} source domain image, 1≤k≤N_{d} and k is a positive integer; N_{d} represents a total number of style representations in the set of the multiple new style representations and the updated target domain style representations; Σᵢ₌₁ⁿ^{ₛ}Σₖ₌₁^{N}^{_{d}} [symbol] _{mda}(xᵢ^{s→d}^{ₖ}, k) represents the discrimination loss function determined according to the discrimination results of the first images and the discrimination results of the second images.

In the above formulas (8) to (10), the discrimination loss function comprises three parts, namely, a source domain discrimination loss function, a target domain loss function, and a discrimination loss function determined according to the discrimination results of the first images and the discrimination results of the second images. Each of the loss functions can be determined according to the following formulas.

$${ℒ}_{mda} ( {x}_{i}^{s} , 0 ) = - {\sum }_{h = 1}^{H} {\sum }_{w = 1}^{W} log ( D ( F ( {x}_{i}^{s} ) ) ( h , w ) ) \qquad ( 12 )$$

$${ℒ}_{mda} ( {x}_{j}^{t} , {c}_{j}^{t} ) = - {\sum }_{h = 1}^{H} {\sum }_{w = 1}^{W} log ( D ( F ( {x}_{j}^{t} ) ) ( {c}_{j}^{t} , h , w ) ) \qquad ( 13 )$$

$${ℒ}_{mda} ( {x}_{i}^{s \to {d}_{k}} , k ) = - {\sum }_{h = 1}^{H} {\sum }_{w = 1}^{W} log ( D ( F ( {x}_{i}^{s \to {d}_{k}} ) ) ( k , h , w ) ) \qquad ( 14 )$$

In formulas (12) to (14), 1≤h≤H, h is a positive integer representing a height of pixels in the image; 1≤w≤W, w is a positive integer representing the width of pixels in the image; H and W represent a maximum height and a maximum width of pixels in the image, respectively; F(⋅) represents a function of the basic representation extraction network and the gradient inversion layer.

In some embodiments, the object detection loss function

and the discrimination loss function are weighted and summed to obtain an overall loss function for adjusting the parameters of the object detection model. The overall loss function can be determined by the following formula.

$$ℒ = {ℒ}_{MDA} + {\sum }_{k = 1}^{{n}_{s}} ( {λ}_{LOC} {ℒ}_{LOC}^{k} + {λ}_{CLS} {ℒ}_{CLS}^{k} ) \qquad ( 15 )$$

In formula (15), λ_{LOC} and λ_{CLS} are the weights of [symbol] _{LOC}^{k} and [symbol] _{CLS}^{k} respectively.

In some embodiments, the parameters of the object detection model and the discriminator are adjusted according to the overall loss function during each training iteration. For the specific training process, reference can be made to the existing technologies, which will not be repeated herein. The basic representation extraction network may adopt a CNN model, such as VGG, ResNet, etc., which are not limited to the examples provided herein.

The training process of this disclosure comprises two stages. In the first stage, a method of generating new styles based on an adversarial exploration is performed with three objectives, namely to generate new style representations that are different from the source domain style representations and the target domain style representations, to generate the new style representations that are different from each other, and to enable images generated by combining the new style representations and the source domain content representations to have semantics consistent with the source domain images. In the second stage, object detection model is trained in an invariant domain. This process is based on pseudo domain labels of the style representations (for example, each target domain image is provided with a pseudo domain label through clustering), and an object detection model and representations that are robust to multiple domains are obtained through an adversarial training mechanism.

In the method of the above embodiments, the multiple new style representations are automatically generated based on the source domain content representations of the source domain images and the target domain style representations of the target domain images. The new style representations generated are different from each other and also different from the source domain style representations and the target domain style representations. Moreover, the semantics of the images generated by combining the new style representations with the source domain content representations are consistent with that of the source domain images. Therefore, the first images generated by combining the new style representations with the updated source domain content representations can be used as training samples for a domain adaptation training of the object detection model. Furthermore, the second images generated by combining the target domain style representations with the updated source domain content representations, as well as the source domain images, can also be used as training samples for a domain adaptation training of the object detection model. By automatically generating the new style representations for training in this disclosure, training efficiency can be improved, and manual annotation costs can be reduced. In addition, the multiple new style representations and the target domain style representations can be used together to generate training samples, resulting in an increased number of styles of the training samples. This enables the trained object detection model to accurately detect images of multiple styles, thereby improving the effectiveness of the object detection model.

The trained object detection model can be used to detect objects in images. In some embodiments, an image to be detected is input to the trained object detection model to obtain an object detection result of the image to be detected.

The present disclosure also provides an image processing apparatus, which will be described below with reference to FIG. 3.

FIG. 3 is a structural diagram of an image processing apparatus according to some embodiments of the present disclosure. As shown in FIG. 3, the apparatus 300 of this embodiment comprises: an obtaining module 310, a representation generation module 320, an image generation module 330, and a training module 340.

The obtaining module 310 is configured to obtain source domain content representations of source domain images and target domain style representations of target domain images.

In some embodiments, the obtaining module 310 is configured to extract the source domain content representations of the source domain images using a content encoder; and extract the target domain style representations of the target domain images using a style encoder.

In some embodiments, the style encoder comprises a style representation extraction network and a clustering module. The obtaining module 310 is configured to input the target domain images to the style representation extraction network to obtain basic style representations of the target domain images; and input the basic style representations of the target domain images to the clustering module for clustering to obtain representation vectors of clustering centers as the target domain style representations.

The representation generation module 320 is configured to generate multiple new style representations and update the source domain content representations and the target domain style representations with an objective that the multiple new style representations, which are different from each other, are different from source domain style representations of the source domain images and the target domain style representations, and that images generated by combining the multiple new style representations and the source domain content representations are semantically consistent with the source domain images.

In some embodiments, the representation generation module 320 is configured to randomly generate a preset number of new style representations, and input the new style representations and the source domain content representations to a generation network to obtain first transfer images; input the target domain style representations and the source domain content representations to the generation network to obtain second transfer images; determine first loss functions according to style differences between the first transfer images and the source domain images, and style differences between the first transfer images and the second transfer images, wherein the first loss functions are used to represent differences between the new style representations and the source domain style representations, and differences between the new style representations and the target domain style representations; determine second loss functions according to style differences among the first transfer images, wherein the second loss functions are used to represent differences among the new style representations; determine third loss functions according to differences between semantic representations of the first transfer images and semantic representations of the source domain images, wherein the third loss functions are used to represent semantic differences between the source domain images and the images generated by combining the new style representations and the source domain content representations; and adjust the new style representations according to the first loss functions, the second loss functions, and the third loss functions until a preset convergence condition corresponding to the objective is satisfied, to obtain the multiple new style representations.

In some embodiments, the representation generation module 320 is configured to adjust parameters of the content encoder, the style encoder, and the generation network according to the first loss functions, the second loss functions, and the third loss functions until the preset convergence condition corresponding to the objective is satisfied; and in a case where the preset convergence condition corresponding to the objective is satisfied, take source domain content representations output by the content encoder as the updated source domain content representations, and target domain style representations output by the style encoder as the updated target domain style representations.

In some embodiments, taking any of the first transfer images and a source domain image corresponding to the any of the first transfer images as a first reference image and a second reference image respectively, or taking the any of the first transfer images and a second transfer image corresponding to the any of the first transfer images as the first reference image and the second reference image respectively, or taking any two of first transfer images as the first reference image and the second reference image respectively, a style difference between the first reference image and the second reference image is determined in the following method: inputting the first reference image and the second reference image to multiple preset representation layers in a pre-trained representation extraction network; for each of the multiple preset representation layers, determining a mean value and a variance of representations of the first reference image output by the each of the multiple preset representation layers as a first mean value and a first variance, and determining a mean value and a variance of representations of the second reference image output by the each of the multiple preset representation layers as second mean value and a second variance; and determining the style difference between the first reference image and the second reference image according to a difference between the first mean value and the second mean value, as well as a difference between the first variance and the second variance corresponding to the each of the multiple preset representation layers.

The first loss function, the second loss function, and

the third loss function can be determined according to formulas (2) to (4), which will not be repeated here.

In some embodiments, the representation generation module 320 is configured to obtain a target loss function by weighting and summing the first loss functions, the second loss functions and the third loss functions; determine a gradient according to the target loss function; and adjust the new style representations according to the gradient and a preset learning rate, wherein a value of each dimension in the randomly generated preset number of the new style representations is randomly sampled from a standard normal distribution.

The image generation module 330 is configured to generate first images by combining the multiple new style representations with the updated source domain content representations and generating second images by combining the updated target domain style representations with the updated source domain content representations.

In some embodiments, the image generation module 330 is configured to in a case where the preset convergence condition corresponding to the objective is satisfied, input the multiple new style representations and the updated source domain content representations to the generation network to obtain the first images, and input the updated target domain style representations and the updated source domain content representations to the generation network to obtain the second images.

The training module 340 is configured to train an object detection model using the first images, the second images and the source domain images to obtain the trained object detection model.

In some embodiments, the training module 340 is configured to input the first images to the object detection model to obtain object detection results of the first images, input the second images to the object detection model to obtain object detection results of the second images, and input the source domain images to the object detection model to obtain object detection results of the source domain images; determine an object detection loss function according to differences of labeling information of the source domain images with the object detection results of the first images, with the object detection results of the second images, and with the object detection results of the source domain images; and adjust parameters of the object detection model according to the object detection loss function.

In some embodiments, the training module 340 is configured to input the first images to a basic representation extraction network of the object detection model to obtain basic representations of the first images, input the second images to the basic representation extraction network of the object detection model to obtain basic representations of the second images, input the source domain images to the basic representation extraction network of the object detection model to obtain basic representations of the source domain images, and input the target domain images to the basic representation extraction network of the object detection model to obtain basic representations of the target domain images; and input the basic representations of the first images to a gradient inversion layer and then to a discrimination network to obtain discrimination results of the first images, input the basic representations of the second images to the gradient inversion layer and then to the discrimination network to obtain discrimination results of the second images, input the basic representations of the source domain images to the gradient inversion layer and then to the discrimination network to obtain discrimination results of the source domain images, and input the basic representations of the target domain images to the gradient inversion layer and then to the discrimination network to obtain discrimination results of the target domain images;

and determine a discrimination loss function according to the discrimination results of the first images, the discrimination results of the second images, the discrimination results of the source domain images, and the discrimination results of the target domain images; and adjust the parameters of the object detection model according to the object detection loss function and the discrimination loss function.

In some embodiments, the object detection results comprise positioning results and classification results, wherein the positioning results are positions of detected objects, the classification results are categories of the detected objects, and the labeling information of the source domain images comprise positions of objects in the source domain images and categories of the objects in the source domain images; the training module 340 is configured to determine positioning loss functions according to differences of the positions of the objects in the source domain images with the positioning results of the first images, with the positioning results of the second images, and with the positioning results of the source domain images; determine classification loss functions according to differences of the categories of the objects in the source domain images with the classification results of the first images, with the classification results of the second images, and with the classification results of the source domain images; and weight and sum the positioning loss functions and the classification loss functions to obtain the object detection loss function.

For the positioning loss functions, the classification loss functions, and the discrimination loss function, reference can be made to the formulas (6) to (15) described in the above embodiments, which will not be repeated here.

In some embodiments, the image processing apparatus 30 further comprises: an object detection module 350 configured to input an image to be detected to the trained object detection model to obtain an object detection result of the image to be detected.

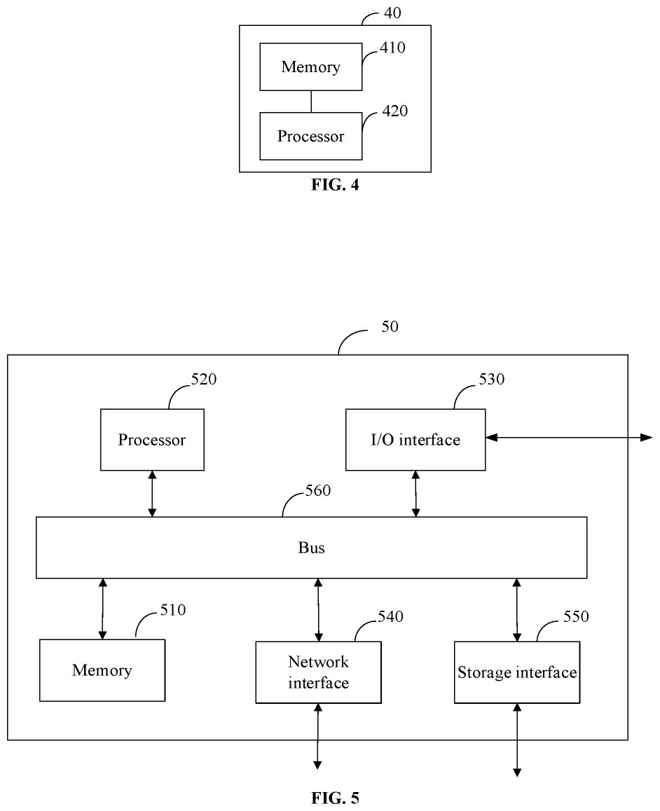

The image processing apparatus of the embodiment of the present disclosure may be implemented by various computing devices or computer systems, which are described below with reference to FIGS. 4 and 5.

FIG. 4 is a structural diagram of an image processing apparatus according to some embodiments of the present disclosure. As shown in FIG. 4, the apparatus 400 of this embodiment comprises memory 410 and a processor 420 coupled to the memory 410, the processor 420 configured to, based on instructions stored in the memory 410, carry out the image processing method according to any one of the embodiments of the present disclosure.

Wherein, the memory 410 may comprise, for example, system memory, a fixed non-volatile storage medium, or the like. The system memory stores, for example, an operating system, applications, a boot loader, a database, and other programs.

FIG. 5 is a structural diagram of an image processing apparatus according to other embodiments of the present disclosure. As shown in FIG. 5, the apparatus 50 of this embodiment comprises: a memory 510 and a processor 520 that are similar to the memory 410 and the processor 420, respectively. It may further comprise an input-output interface 530, a network interface 540, a storage interface 550, and the like. These interfaces 530, 540, 550, the memory 510 and the processor 520 may be connected through a bus 560, for example. Wherein, the input-output interface 530 provides a connection interface for input-output devices such as a display, a mouse, a keyboard, and a touch screen. The network interface 540 provides a connection interface for various networked devices, for example, it can be connected to a database server or a cloud storage server. The storage interface 550 provides a connection interface for external storage devices such as an SD card and a USB flash disk.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (comprising but not limited to disk storage, CD-ROM, optical storage device, etc.) having computer-usable program code embodied therein.

The present disclosure is described with reference to flowcharts and/or block diagrams of methods, apparatuses (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing device to generate a machine such that the instructions executed by a processor of a computer or other programmable data processing device to generate means implementing the functions specified in one or more flows of the flowcharts and/or one or more blocks of the block diagrams.

The computer program instructions may also be stored in a computer readable storage device capable of directing a computer or other programmable data processing apparatus to operate in a specific manner such that the instructions stored in the computer readable storage device produce an article of manufacture comprising instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

The above is merely preferred embodiments of this disclosure and is not limitation to this disclosure. Within spirit and principles of this disclosure, any modification, replacement, improvement and etc. shall be contained in the protection scope of this disclosure.

What is claimed is:

1. An image processing method, comprising:
obtaining source domain content representations of source domain images and target domain style representations of target domain images;
generating multiple new style representations and updating the source domain content representations and the target domain style representations with an objective that the multiple new style representations, which are different from each other, are different from source domain style representations of the source domain images and the target domain style representations, and that images generated by combining the multiple new style representations and the source domain content representations are semantically consistent with the source domain images;
generating first images by combining the multiple new style representations with the updated source domain content representations and generating second images by combining the updated target domain style representations with the updated source domain content representations; and
training an object detection model using the first images, the second images and the source domain images to obtain the trained object detection model.

2. The image processing method according to claim 1, wherein the obtaining source domain content representations of source domain images and target domain style representations of target domain images comprises:
extracting the source domain content representations of the source domain images using a content encoder; and
extracting the target domain style representations of the target domain images using a style encoder.

3. The image processing method according to claim 2, wherein the style encoder comprises a style representation extraction network and a clustering module and the extracting the target domain style representations of the target domain images using a style encoder comprises:
inputting the target domain images to the style representation extraction network to obtain basic style representations of the target domain images; and
inputting the basic style representations of the target domain images to the clustering module for clustering to obtain representation vectors of clustering centers as the target domain style representations.

4. The image processing method according to claim 2, wherein the generating multiple new style representations comprises:
randomly generating a preset number of new style representations, and inputting the new style representations and the source domain content representations to a generation network to obtain first transfer images;
inputting the target domain style representations and the source domain content representations to the generation network to obtain second transfer images;
determining first loss functions according to style differences between the first transfer images and the source domain images, and style differences between the first transfer images and the second transfer images, wherein the first loss functions are used to represent differences between the new style representations and the source domain style representations, and differences between the new style representations and the target domain style representations;
determining second loss functions according to style differences among the first transfer images, wherein the second loss functions are used to represent differences among the new style representations;
determining third loss functions according to differences between semantic representations of the first transfer images and semantic representations of the source domain images, wherein the third loss functions are used to represent semantic differences between the source domain images and the images generated by combining the new style representations and the source domain content representations; and
adjusting the new style representations according to the first loss functions, the second loss functions, and the third loss functions until a preset convergence condition corresponding to the objective is satisfied, to obtain the multiple new style representations.

5. The image processing method according to claim 4, wherein the updating the source domain content representations and the target domain style representations comprises:
adjusting parameters of the content encoder, the style encoder, and the generation network according to the first loss functions, the second loss functions, and the third loss functions until the preset convergence condition corresponding to the objective is satisfied; and
in a case where the preset convergence condition corresponding to the objective is satisfied, taking source domain content representations output by the content encoder as the updated source domain content representations, and target domain style representations output by the style encoder as the updated target domain style representations.

6. The image processing method according to claim 4, wherein taking any of the first transfer images and a source domain image corresponding to the any of the first transfer images as a first reference image and a second reference image respectively, or taking the any of the first transfer images and a second transfer image corresponding to the any of the first transfer images as the first reference image and the second reference image respectively, or taking any two of first transfer images as the first reference image and the second reference image respectively, a style difference between the first reference image and the second reference image is determined in the following method:
inputting the first reference image and the second reference image to multiple preset representation layers in a pre-trained representation extraction network;
for each of the multiple preset representation layers, determining a mean value and a variance of representations of the first reference image output by the each of the multiple preset representation layers as a first mean value and a first variance, and determining a mean value and a variance of representations of the second reference image output by the each of the multiple preset representation layers as second mean value and a second variance; and
determining the style difference between the first reference image and the second reference image according to a difference between the first mean value and the second mean value, as well as a difference between the first variance and the second variance corresponding to the each of the multiple preset representation layers.

7. The image processing method according to claim 4, wherein each of the first loss functions is determined using the following formula:
$${ℒ}_{nov}^{i , k} = \frac{{n}_{s}}{n} max \{ 0 , {T}_{nov} - d ( {x}_{k}^{s} , {x}_{k}^{s \to {n}_{i}} ) \} + {\sum }_{j = 1}^{{K}_{t}} \frac{{n}_{j}}{n} max \{ 0 , {T}_{nov} - d ( {x}_{k}^{s \to {t}_{j}} , {x}_{k}^{s \to {n}_{i}} ) \}$$
wherein [symbol] ₙₒᵥ^{k} represents a first loss function corresponding to an i^{th} new style representation and a k^{th} source domain image; k is a positive integer, 1≤k≤nₛ; i is a positive integer; n=nₛ+nₜ represents a total number of the source domain images and the target domain images, nₛ and nₜ represent a number of the source domain images and a number of the target domain images respectively; nⱼ represents a number of the target images corresponding to a j^{th} target domain style representation; Kₜ represents a number of the target domain style representations; Tₙₒᵥ is a hyperparameter representing a maximized distance threshold; j is a positive integer, 1≤j≤Kₜ; xₖ^{s} represents the k^{th} source domain image; xₖ^{s→n}^{ᵢ} represents a first transfer image generated by inputting the i^{th} new style representation and a source domain content representation of the k^{th} source domain image to the generation network; xₖ^{s→t}^{ⱼ} represents a second transfer image generated by inputting the j^{th} target domain style representation and the source domain content representation of the k^{th} source domain image to the generation network; and d(⋅) represents a determination function of a style difference between two images.

8. The image processing method according to claim 4, wherein each of the second loss functions is determined using the following formula:
$${ℒ}_{div}^{i , k} = \frac{1}{{K}_{n} - 1} {\sum }_{j = 1 , j \neq i}^{{K}_{n}} max \{ 0 , {T}_{div} - {d}_{s} ( {x}_{k}^{s \to {n}_{j}} , {x}_{k}^{s \to {n}_{i}} ) \}$$
wherein [symbol] _{div}^{i,k} represents a second loss function corresponding to an i^{th} new style representation and a k^{th} source domain image, 1≤i≤Kₙ; i is a positive integer; Kₙ represents the preset number; T_{div} is a hyperparameter representing a maximized distance threshold; xₖ^{s→n}^{ⱼ} represents a first transfer image generated by inputting a j^{th}new style representation and a source domain content representation of the k^{th} source domain image to the generation network, wherein j is a positive integer, 1≤j≤Kₙ; x^{s→n}^{ᵢ} represents a first transfer image generated by inputting the i^{th} new style representation and the source domain content representation of the k^{th}source domain image to the generation network; and d(⋅) represents a determination function of a style difference between two images.

9. The image processing method according to claim 4, wherein each of the third loss functions is determined using the following formula:
$${ℒ}_{sm}^{i , k} = {‖ {ϕ}_{sm} ( {x}_{k}^{s} ) - {ϕ}_{sm} ( {x}_{k}^{s \to {n}_{i}} ) ‖}_{2}$$
wherein [symbol] ₛₘ^{i,k} represents a third loss function corresponding to an i^{th} new style representation and a k^{th} source domain image; ϕₛₘ(⋅) represents a function of a semantic representation extractor; xₖ^{s} represents the k^{th} source domain image; and xₖ^{s→n}^{ᵢ} represents a first transfer image obtained by inputting the i^{th} new style representation and a source domain content representation of the k^{th} source domain image to the generation network.

10. The image processing method according to claim 4, wherein the adjusting the new style representations according to the first loss functions, the second loss functions, and the third loss functions comprises:
obtaining a target loss function by weighting and summing the first loss functions, the second loss functions and the third loss functions;
determining a gradient according to the target loss function; and
adjusting the new style representations according to the gradient and a preset learning rate, wherein a value of each dimension in the randomly generated preset number of the new style representations is randomly sampled from a standard normal distribution.

11. The image processing method according to claim 5, wherein the generating first images by combining the multiple new style representations with the updated source domain content representations and generating second images by combining the updated target domain style representations with the updated source domain content representations comprises:
in a case where the preset convergence condition corresponding to the objective is satisfied, inputting the multiple new style representations and the updated source domain content representations to the generation network to obtain the first images, and inputting the updated target domain style representations and the updated source domain content representations to the generation network to obtain the second images.

12. The image processing method according to claim 1, wherein the training an object detection model using the first images, the second images and the source domain images comprises:
inputting the first images to the object detection model to obtain object detection results of the first images, inputting the second images to the object detection model to obtain object detection results of the second images, and inputting the source domain images to the object detection model to obtain object detection results of the source domain images;
determining an object detection loss function according to differences of labeling information of the source domain images with the object detection results of the first images, with the object detection results of the second images, and with the object detection results of the source domain images; and
adjusting parameters of the object detection model according to the object detection loss function.

13. The image processing method according to claim 12, wherein the training an object detection model using the first images, the second images and the source domain images further comprises:
inputting the first images to a basic representation extraction network of the object detection model to obtain basic representations of the first images, inputting the second images to the basic representation extraction network of the object detection model to obtain basic representations of the second images, inputting the source domain images to the basic representation extraction network of the object detection model to obtain basic representations of the source domain images, and inputting the target domain images to the basic representation extraction network of the object detection model to obtain basic representations of the target domain images; and
inputting the basic representations of the first images to a gradient inversion layer and then to a discrimination network to obtain discrimination results of the first images, inputting the basic representations of the second images to the gradient inversion layer and then to the discrimination network to obtain discrimination results of the second images, inputting the basic representations of the source domain images to the gradient inversion layer and then to the discrimination network to obtain discrimination results of the source domain images, and inputting the basic representations of the target domain images to the gradient inversion layer and then to the discrimination network to obtain discrimination results of the target domain images; and
determining a discrimination loss function according to the discrimination results of the first images, the discrimination results of the second images, the discrimination results of the source domain images, and the discrimination results of the target domain images,
wherein the adjusting parameters of the object detection model according to the object detection loss function comprises:
adjusting the parameters of the object detection model according to the object detection loss function and the discrimination loss function.

14. The image processing method according to claim 12, wherein the object detection results comprise positioning results and classification results, wherein the positioning results are positions of detected objects, the classification results are categories of the detected objects, and the labeling information of the source domain images comprise positions of objects in the source domain images and categories of the objects in the source domain images; and
the determining an object detection loss function according to the differences of labeling information of the source domain images with the object detection results of the first images, with the object detection results of the second images, and with the object detection results of the source domain images comprises:
determining positioning loss functions according to differences of the positions of the objects in the source domain images with the positioning results of the first images, with the positioning results of the second images, and with the positioning results of the source domain images;
determining classification loss functions according to differences of the categories of the objects in the source domain images with the classification results of the first images, with the classification results of the second images, and with the classification results of the source domain images; and
weighting and summing the positioning loss functions and the classification loss functions to obtain the object detection loss function.

15. The image processing method according to claim 14, wherein each of the positioning loss functions is determined using the following formula:
$${ℒ}_{LOC}^{k} = {ℒ}_{loc} ( {x}_{k}^{s} , {y}_{k , l}^{s} ) + {\sum }_{i = 1}^{{N}_{d}} {ℒ}_{loc} ( {x}_{k}^{s \to {d}_{i}} , {y}_{k , l}^{s} )$$
wherein [symbol] _{LOC}^{k} represents a positioning loss corresponding to a k^{th} source domain image; xₖ^{s} represents the k^{th} source domain image; y_{k,l}^{s} represents a position of an object in the k^{th} source domain image, [symbol] _{loc}(xₖ^{s}, y_{k,l}^{s}) represents a positioning loss determined by a positioning result of the k^{th} source domain image and the position of the object in the k^{th} source domain image; dᵢ represents an i^{th} style representation in a set of the multiple new style representations and the updated target domain style representations; xₖ^{s→d}^{ᵢ} represents an image generated by combining the i^{th} style representation with a source domain content representation updated of the k^{th} source domain image, which is one of the first images or one of the second images; [symbol] _{loc}(xₖ^{s→d}^{ᵢ}, y_{k,l}^{s}) represents a positioning loss corresponding a the positioning result of the image xₖ^{s→d}^{ᵢ} and the position of the object in the k^{th} source domain image, 1≤i≤N_{d} and i is a positive integer; and N_{d} represents a total number of style representations in the set of the multiple new style representations and the updated target domain style representations.

16. The image processing method according to claim 14, wherein each of the classification loss functions is determined using the following formula:
$${ℒ}_{CLS}^{k} = {ℒ}_{cls} ( {x}_{k}^{s} , {y}_{k , c}^{s} ) + {\sum }_{i = 1}^{{N}_{d}} {ℒ}_{cls} ( {x}_{k}^{s \to {d}_{i}} , {y}_{k , c}^{s} )$$
wherein [symbol] _{CLS}^{k} represents a classification loss corresponding to a k^{th} source domain image; xₖ^{s} represents the k^{th} source domain image; y_{k,c}^{s} represents a category of an object in the k^{th} source domain image; [symbol] _{cls}(xₖ^{s}, y_{k,c}^{s}) is the classification loss corresponding to a classification result of the k^{th} source domain image and the category of the object in the k^{th} source domain image; dᵢ represents an i^{th} style representation in a set of the multiple new style representations and the updated target domain style representations; xₖ^{s→d}^{ₛ} represents an image generated by combining the i^{th} style representation with a source domain content representation updated of the k^{th} source domain image, which is one of the first images or one of the second images; [symbol] _{cls}(xₖ^{s→d}^{ᵢ}, y_{k,c}^{s}) represents a classification loss corresponding to a classification result of the image xₖ^{s→d}^{ᵢ} and the category of the object in the k^{th} source domain image, 1≤i≤N_{d} and i is a positive integer; and N_{d} represents a total number of style representations in the set of the multiple new style representations and the updated target domain style representations.

17. The image processing method according to claim 13, wherein the discrimination loss function is determined using the following formulas:
$${ℒ}_{MDA}^{s} = {\sum }_{i = 1}^{{n}_{s}} {ℒ}_{mda} ( {x}_{i}^{s} , 0 ) \\ {ℒ}_{MDA}^{t} = {\sum }_{j = 1}^{{n}_{t}} {ℒ}_{mda} ( {x}_{j}^{t} , {c}_{j}^{t} ) \\ {ℒ}_{MDA}^{ST} = {\sum }_{i = 1}^{{n}_{s}} {\sum }_{k = 1}^{{N}_{d}} {ℒ}_{mda} ( {x}_{i}^{s \to {d}_{k}} , k ) \\ {ℒ}_{MDA} = {ℒ}_{MDA}^{s} + {ℒ}_{MDA}^{t} + {ℒ}_{MDA}^{ST}$$
wherein xᵢ^{s} represents an i^{th} source domain image; nₛ represents a number of the source domain images; Σᵢ₌₁ⁿ^{ₛ} [symbol] _{mda}(xᵢ^{s}, 0) represents a source domain discrimination loss function determined according to the discrimination results of the source domain images; xⱼ^{t} represents a j^{th} target domain image; cⱼ^{t} represents a style to which the j^{th} target domain image belongs; nₜ represents a number of the target domain images, 1≤j≤nₜ and j is a positive integer; Σⱼ₌₁ⁿ^{ᵢ} [symbol] _{mda}(xⱼ^{t}, cⱼ^{t}) represents a target domain discrimination loss function determined according to the discrimination results of the target domain images; dₖ represents a k^{th} style representation in a set of the multiple new style representations and the updated target domain style representations; xₖ^{s→d}^{ᵢ} represents an image generated by combining the k^{th} style representation with a source domain content representation updated of the i^{th} source domain image, 1≤k≤N_{d} and k is a positive integer; N_{d} represents a total number of style representations in the set of the multiple new style representations and the updated target domain style representations; and Σᵢ₌₁ⁿ^{ₛ}Σₖ₌₁^{N}^{_{d}} [symbol] _{mda}(xᵢ^{s→d}^{ₖ}, k) represents the discrimination loss function determined according to the discrimination results of the first images and the discrimination results of the second images.

18. The image processing method according to claim 17, wherein:
$${ℒ}_{mda} ( {x}_{i}^{s} , 0 ) = - {\sum }_{h = 1}^{H} {\sum }_{w = 1}^{W} log ( D ( F ( {x}_{i}^{s} ) ) ( h , w ) ) \\ {ℒ}_{mda} ( {x}_{j}^{t} , {c}_{j}^{t} ) = - {\sum }_{h = 1}^{H} {\sum }_{w = 1}^{W} log ( D ( F ( {x}_{j}^{t} ) ) ( {c}_{j}^{t} , h , w ) ) \\ {ℒ}_{mda} ( {x}_{i}^{s \to {d}_{k}} , k ) = - {\sum }_{h = 1}^{H} {\sum }_{w = 1}^{W} log ( D ( F ( {x}_{i}^{s \to {d}_{k}} ) ) ( k , h , w ) )$$
wherein 1≤h≤H, h is a positive integer representing a height of pixels in the image; 1≤w≤W, w is a positive integer representing the width of pixels in the image; H and W represent a maximum height and a maximum width of pixels in the image, respectively; and F(⋅) represents a function of the basic representation extraction network and the gradient inversion layer.

19. The image processing method according to claim 1, further comprising:
inputting an image to be detected to the trained object detection model to obtain an object detection result of the image to be detected.

20. An image processing apparatus, comprising:
an obtaining module configured to obtain source domain content representations of source domain images and target domain style representations of target domain images;
a representation generation module configured to generate multiple new style representations and update the source domain content representations the and target domain style representations with an objective that the multiple new style representations, which are different from each other, are different from source domain style representations of the source domain images and the target domain style representations, and that images generated by combining the multiple new style representations and the source domain content representations are semantically consistent with the source domain images;
an image generation module configured to generate first images by combining the multiple new style representations with the updated source domain content representations and generate second images by combining the updated target domain style representations with the updated source domain content representations; and
a training module configured to train an object detection model using the first images, the second images and the source domain images to obtain the trained object detection model.

21. An image processing apparatus, comprising:
a processor; and
a memory coupled to the processor for storing instructions, which when executed by the processor, cause the processor to execute the image processing method according to any one of claims 1 to 19.

22. A non-transitory computer-readable storage medium having a computer program stored thereon, wherein the program when executed by a processor, cause the processor to implement the steps of the method according to any one of claims 1 to 19.
